(19) United States
(12) Patent Application Publication
(10) Pub. No.: US 2016/0230735 A1
(43) Pub. Date: Aug. 11, 2016

(54) ENGINE STOP CONTROL DEVICE

(71) Applicant: TOYOTA JIDOSHA KABUSHIKI KAISHA, Toyota-shi, Aichi (JP)

(72) Inventor: Hiroya TANAKA, Miyoshi-shi (JP)

(73) Assignee: TOYOTA JIDOSHA KABUSHIKI KAISHA, Toyota-shi, Aichi-ken (JP)

(21) Appl. No.: 15/028,505

(22) PCT Filed: Nov. 24, 2014
(86) PCT No.: PCT/JP2014/005873

§ 371 Date: Apr. 11, 2016

(30) Foreign Application Priority Data
Dec. 24, 2013 (JP) 2013-265224

(51) Int. Cl. F02N 11/08; F02D 41/04

(52) U.S. Cl. CPC F02N 11/0833; F02D 41/042

(57) ABSTRACT

An engine stop control device stops an engine if the vehicle speed is less than the prescribed vehicle speed and the booster negative pressure of a brake booster is greater than or equal to the prescribed negative pressure. The engine stop control device includes an ejector, which increases a booster negative pressure, and a controller programmed to control the engine and the ejector. If the vehicle speed is greater than or equal to the prescribed vehicle speed and a driving load of an auxiliary machine of the engine is greater than or equal to a prescribed load, the controller drives the ejector.

### TECHNICAL FIELD

The present invention relates to an engine stop control device that stops an engine if a vehicle speed is less than a prescribed vehicle speed and a booster negative pressure of a brake booster is greater than or equal to a prescribed negative pressure.

### BACKGROUND ART

An engine stop control device that performs an economy running control to limit fuel consumption during idling, such as when a vehicle is in a stopped state waiting for a traffic light, is publicly known. In the economy running control, the engine is stopped when the vehicle is in a stopped state or is reducing the speed to stop, and the engine is restarted when the vehicle starts. Patent Document 1 discloses an engine stop control device. In the device, the above engine stop is performed under a necessary condition in which the negative pressure (booster negative pressure) of the brake booster is greater than or equal to a prescribed negative pressure to limit a shortage of the booster negative pressure.

### CITATION LIST

### Patent Literature

[PTL 1]

Japanese Laid-Open Patent Publication No. 2011-064188

### SUMMARY OF INVENTION

### Technical Problem

In summer, in which the frequency of using an air conditioner is high, an engine load caused by a driving load of a compressor for an air conditioner increases. This reduces the intake pipe negative pressure so that a shortage of the booster negative pressure generated by introducing the intake pipe negative pressure is likely to be caused. When the driving loads of auxiliary machines other than the compressor for an air conditioner, such as an alternator, are high, the intake pipe negative pressure is reduced so that a shortage of the booster negative pressure is likely to be caused in the same way. Accordingly, as in the above document 1, if the condition in which the booster negative pressure is greater than or equal to the prescribed negative pressure is a necessary condition for performing the engine stop, the performing of the engine stop is likely to be inhibited due to the shortage of the booster negative pressure when the driving loads of the auxiliary machines are high. This reduces opportunities for performing the engine stop, so that the fuel consumption improvement effect by the engine stop control may be reduced.

An objective of the present invention is to provide an engine stop control device that properly ensures a booster negative pressure and opportunities for performing the engine stop.

### Solution to Problem

To achieve the foregoing objective and in accordance with an aspect of the present invention, an engine stop control device that stops an engine if a vehicle speed is less than a prescribed vehicle speed and a booster negative pressure of a brake booster is greater than or equal to a prescribed negative pressure is provided. The engine stop control device includes: an ejector and a controller. The ejector increases the booster negative pressure. The controller is programmed to control the engine and the ejector. If a condition in which the vehicle speed is greater than or equal to the prescribed vehicle speed and a driving load of an auxiliary machine of the engine is greater than or equal to a prescribed load is satisfied, the controller drives the ejector.

### BRIEF DESCRIPTION OF DRAWINGS

[FIG. 1]

FIG. 1 is a diagram schematically illustrating a configuration of an engine stop control device according to one embodiment;

[FIG. 2]

FIG. 2 is a flowchart illustrating a process of performing an ejector driving control routine performed in the engine stop control device of FIG. 1; and

[FIG. 3]

FIG. 3 is a time chart illustrating an example of a control mode before and after the stopping of a vehicle in the engine stop control device of FIG. 1.

### DESCRIPTION OF EMBODIMENTS

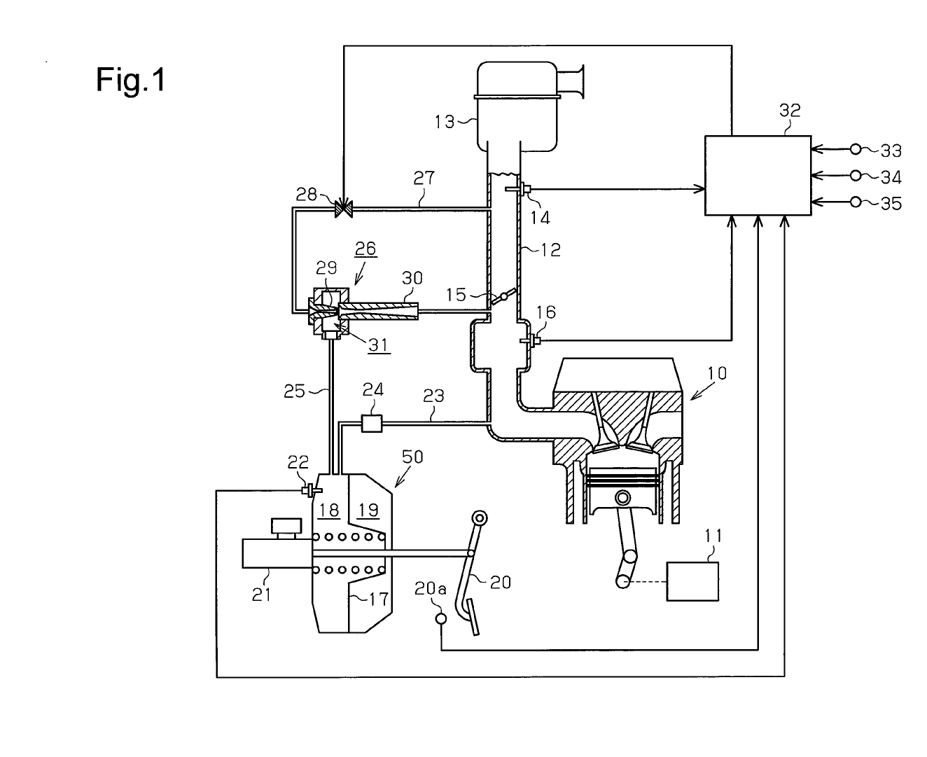

Hereinafter, an engine stop control device according to one embodiment will be described in details with reference to FIGS. 1 to 3.

The engine stop control device according to the present embodiment is applied to an engine 10 to be mounted on a vehicle. As shown in FIG. 1, a compressor 11 for an air conditioner, which compresses the refrigerant for cooling the passenger compartment, is connected to the engine 10. The compressor 11 is one of auxiliary machines driven by the power of the engine 10. An air cleaner 13, an airflow meter 14, a throttle valve 15, and an intake pipe negative pressure sensor 16 are sequentially provided in this order from the upstream portion in an intake passage 12 of the engine 10. The air cleaner 13 filters the intake air introduced into the intake passage 12 to remove dust. The airflow meter 14 detects the flow rate (intake air amount GA) of the intake air, which flows through the intake passage 12. The throttle valve 15 adjusts the intake air amount GA by changing the flow passage area of the intake passage 12. The intake pipe negative pressure sensor 16 detects the magnitude of the negative pressure (intake pipe negative pressure) generated in the downstream portion of the intake passage 12 from the throttle valve 15.

The vehicle on which the above engine 10 is mounted includes a brake booster 50. The inside of the brake booster 50 is sectioned by a diaphragm 17 into a negative pressure chamber 18 and an atmospheric pressure chamber 19. The brake booster 50 uses the pressure difference between the negative pressure (booster negative pressure) introduced into the negative pressure chamber 18 and the atmospheric pressure introduced into the atmospheric pressure chamber 19 to boost and transfer the depressing force applied to a brake pedal 20 to a brake master cylinder 21. This assists the braking operation of the driver. The brake booster 50 includes a booster negative pressure sensor 22, which detects the booster negative pressure in the negative pressure chamber 18. The brake pedal 20 is provided with a brake switch 20a, which is turned ON in accordance with the depressing of the brake pedal 20.

The negative pressure chamber 18 of the brake booster 50 is connected through an intake pipe negative pressure introducing passage 23 to a portion of the intake passage 12 that is downstream of the throttle valve 15. The intake pipe negative pressure introducing passage 23 is provided with a vacuum valve 24, which serves as a check valve and is opened when the booster negative pressure is less than the intake pipe negative pressure.

The negative pressure chamber 18 of the brake booster 50 is also connected through an ejector suction passage 25 to the ejector 26. The ejector 26 operates with the intake air as a driving gas to suction the air in the negative pressure chamber 18 to increase the booster negative pressure. The ejector 26 is provided in a bypass passage 27, which connects the upstream portion and the downstream portion of the intake passage 12 with respect to the throttle valve 15. An electromagnetic on-off valve 28, which selectively opens and closes the bypass passage 27, is provided in the bypass passage 27.

The ejector 26 includes a nozzle 29, a diffusor 30, and a suction chamber 31. The intake air flows from the upstream portion of the intake passage 12 with respect to the throttle valve 15 through the bypass passage 27 into the ejector 26. The nozzle 29 constricts the flow of intake air into the ejector 26 and squirts the intake air into the suction chamber 31. The diffusor 30 reduces the speed of the intake air squirted through the nozzle 29, increases the pressure of the intake air, and discharges the intake air. The above ejector suction passage 25 is connected to the suction chamber 31.

The above ejector 26 operates as follows. When the on-off valve 28 is opened in the state in which the differential pressure in the intake passage 12 between the upstream pressure and the downstream pressure of the throttle valve 15 (hereinafter, referred to as ejector differential pressure) is sufficiently high, the intake air flows from the upstream portion through the bypass passage 27 to the downstream portion with respect to the throttle valve 15. At this time, the intake air that has flowed into the ejector 26 provided in the bypass passage 27 is accelerated according to the constriction of the nozzle 29. This reduces the pressure of the intake air, and the intake air is squirted into the suction chamber 31. The intake air is expanded and diffused in the suction chamber 31 and then flows into the diffusor 30. After the speed of the intake air is reduced in the diffusor 30 and the pressure of the intake air is increased, the intake air is returned through the bypass passage 27 to the downstream portion of the intake passage 12 from the throttle valve 15. In the suction chamber 31 at this time, a negative pressure is generated by a high speed and low pressure intake airflow squirted through the nozzle 29. The air in the negative pressure chamber 18 of the brake booster 50 is drawn through the ejector suction passage 25 into the suction chamber 31 in which the negative pressure is generated, and then joins the intake air squirted through the nozzle 29. As a result, the negative pressure in the negative pressure chamber 18 into which the air is drawn, i.e., the booster negative pressure is increased.

The engine 10, which includes the above ejector 26, is controlled by an electronic control unit 32. The electronic control unit 32 includes a central processing unit (CPU), which performs an arithmetic processing for the engine control, a read only memory (ROM), which stores programs and data for the engine control, and a random access memory (RAM), which temporarily stores the arithmetic result of the CPU and the detection results of sensors.

The electronic control unit 32 inputs detection signals of various sensors for detecting the operation state of the engine 10 and the running state of the vehicle including the above airflow meter 14, the intake pipe negative pressure sensor 16, and the booster negative pressure sensor 22. The sensors include an accelerator pedal sensor 33, which detects the amount of depressing of the accelerator pedal (amount of accelerator operation), a refrigerant pressure sensor 34, which detects the pressure of the refrigerant compressed by the above compressor 11, and a vehicle speed sensor 35, which detects the vehicle speed. Strictly, the vehicle speed sensor 35 detects the rotation speed of the wheels. The vehicle speed is obtained through an arithmetic calculation from the detection result of the rotation speed of the wheels.

The electronic control unit 32 performs an engine stop control that stops the engine 10 as part of the engine control. That is, the electronic control unit 32 corresponds to a controller programmed to control the engine 10. The stopping of the engine 10 through the engine stop control is performed when the amount of accelerator operation is zero, a brake switch 20a is ON, and the vehicle speed is lowered to be less than the prescribed stop permission vehicle speed Sa. In the present embodiment, the stop permission vehicle speed Sa corresponds to the prescribed vehicle speed and the first prescribed vehicle speed.

However, to ensure the operability of the vehicle brake, the engine stop through the engine stop control is inhibited when the booster negative pressure is not over the prescribed stop inhibition negative pressure Pb even if the amount of accelerator operation is zero and the vehicle speed is less than the stop permission vehicle speed Sa. To perform the engine stop control to stop the engine 10, it is required that the vehicle speed be less than the stop permission vehicle speed Sa and that the booster negative pressure be greater than or equal to the stop inhibition negative pressure Pb. That is, these two conditions are necessary conditions for performing the engine stop control. The engine 10 stopped by the engine stop control is restarted when the condition for performing the engine stop fails to be met, such as when the depressing of the accelerator pedal is not zero, the brake switch is OFF, or the booster negative pressure is reduced.

Ejector Driving Control

The electronic control unit 32 also performs a driving control of the ejector 26 for ensuring the booster negative pressure. That is, the electronic control unit 32 corresponds to a controller programmed to control the ejector 26. Hereinafter, the driving control of the above ejector 26 will be described in details.

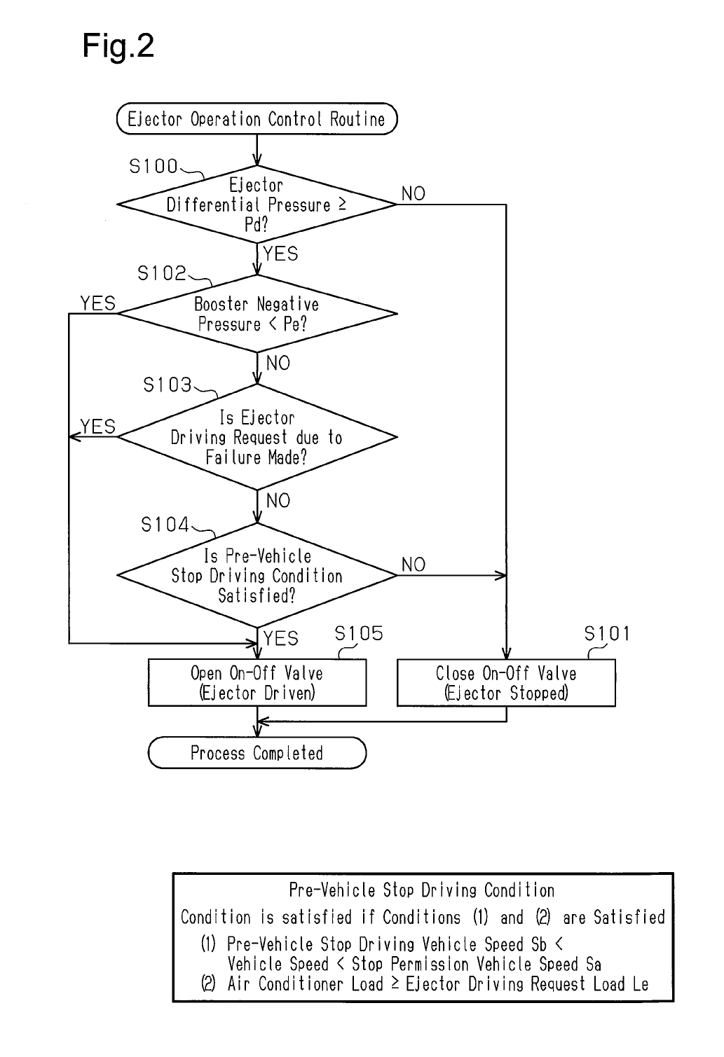

FIG. 2 shows a flowchart of the ejector driving control routine for the driving control of the ejector 26. The process of the routine is repeatedly performed by the electronic control unit 32 during the operation of the engine 10 for every prescribed control cycle.

If the process of the present routine is started, first in step S100, the electronic control unit 32 determines whether the above ejector differential pressure is greater than or equal to a prescribed ejector drivable differential pressure Pd. The minimum value of the ejector differential pressure required for driving the ejector 26 is set as the value of the ejector drivable differential pressure Pd. That is, the determination is performed to check whether the ejector 26 is in the drivable state. In the present embodiment, the ejector differential pressure is checked according to the detection result of the intake pipe negative pressure sensor 16 or the booster negative pressure sensor 22, for example.

If the ejector differential pressure is less than the ejector drivable differential pressure Pd (S100: NO), the process proceeds to step S101. In step S101, the electronic control unit 32 closes the on-off valve 28 to stop the ejector 26. After the on-off valve 28 is closed, the process of the present routine this time is ended.

In contrast, if the ejector differential pressure is greater than or equal to the ejector drivable differential pressure Pd (S100: YES), the process proceeds to step S102. In step S102, the electronic control unit 32 determines whether the booster negative pressure is less than the prescribed ejector driving negative pressure Pe. The value that is greater than the above stop inhibition negative pressure Pb is set as the value of the ejector driving negative pressure Pe. If the booster negative pressure is less than the ejector driving negative pressure Pe (S102: YES), the process proceeds to step S105. In step S105, the electronic control unit 32 opens the on-off valve 28 to drive the ejector 26. After the on-off valve 28 is opened, the process of the present routine this time is completed.

In above step S102, if the booster negative pressure is determined to be greater than or equal to the prescribed ejector driving negative pressure Pe (S102: NO), the process proceeds to step S103. In step S103, the electronic control unit 32 determines whether the ejector driving request due to failure is made. If the ejector driving request due to failure is made at this time (S103: YES), the process proceeds to above step S105, and the ejector 26 is driven. In contrast, if the ejector driving request due to failure is not made (S103: NO), the process proceeds to step S104.

The ejector driving request due to failure is made when a failure that causes a reduction of the intake pipe negative pressure occurs. The failure includes a throttle failure, an intake VVT advanced ignition failure, an exhaust VVT retarded ignition failure, an intake pipe negative pressure sensor failure, and an NE sensor failure, for example.

The throttle failure occurs when the intentional control of the opening degree of the throttle valve 15 (throttle opening) fails. At this time, the fail-safe measures that set the opening degree of the throttle to an opening degree for an evacuation travel that can be set by only hardware are taken. Since a sufficient intake pipe negative pressure is not generated in this case, the booster negative pressure is ensured by driving the ejector 26.

The intake VVT advanced ignition failure occurs when the intake VVT, in which the valve timing of the intake valve is variable, fails so that retardation of the valve timing of the intake valve fails. The exhaust gas VVT retarded ignition failure occurs when the exhaust VVT, in which the valve timing of the exhaust valve is variable, fails so that advancement of the valve timing of the exhaust valve fails. At the time of occurring of the failures, the amount of air to be introduced into the combustion chamber is out of the intentional control. This may cause an unstable combustion especially in the low load region of the engine 10. Accordingly, when the failures occur, the fail-safe measures that increase the idling rotation speed of the engine 10 are taken to avoid misfire. In this case, the opening degree of the throttle at the time of the idling operation is increased to be greater than the opening degree in the normal operation so that the intake pipe negative pressure that occurs at the time of the idling operation is less than the intake pipe negative pressure that occurs at the time of the normal operation. Accordingly, the booster negative pressure is ensured by driving the ejector 26.

The intake pipe negative pressure sensor failure occurs when the intake pipe negative pressure is not correctly determined due to a failure of the intake pipe negative pressure sensor 16, for example. The NE sensor failure occurs when the engine rotation speed is not correctly determined due to factors such as the failure of the NE sensor, which detects the engine rotation speed. Since the combustion state of the engine 10 is not correctly determined at the time of occurring of the failures, the fail-safe measures that increase the idling rotation speed of the engine 10 are also taken at this time to more reliably maintain the combustion of the engine 10. Accordingly, the booster negative pressure is ensured by driving the ejector 26 at the time of the failures as well.

As described above, in the ejector driving control, if the booster negative pressure is reduced to be less than the ejector driving negative pressure Pe, the booster negative pressure is recovered by driving the ejector 26. This reduces the frequency in which the engine stop by the engine stop control is inhibited due to the shortage of the booster negative pressure. When a sufficient intake pipe negative pressure is not generated due to the failure, the booster negative pressure is ensured by driving the ejector 26.

Further, in the present embodiment, the electronic control unit 32 drives the ejector 26 in the following cases as well. That is, in the above ejector driving control routine, if the booster negative pressure is not less than the ejector driving negative pressure Pe (S102: NO), or if the ejector driving request due to failure is not made (S103: NO), the process proceeds to step S104. In step S104, the electronic control unit 32 determines whether a pre-vehicle stop driving condition is satisfied. If the pre-vehicle stop driving condition is satisfied (S104: YES), in above step S105, the electronic control unit 32 opens the on-off valve 28, and drives the ejector 26.

The pre-vehicle stop driving condition is satisfied if the following conditions (1) and (2) are satisfied. That is, the condition (1) refers to a state in which the vehicle speed is greater than or equal to the above stop permission vehicle speed Sa and less than the pre-vehicle stop driving vehicle speed Sb, and the condition (2) refers to a state in which the power loss of the engine 10 for driving the compressor 11 for an air conditioner, i.e., the load of the air conditioner is greater than or equal to a prescribed ejector driving request load Le. The air conditioner load is obtained based on the detection result of the refrigerant pressure sensor 34. A value that is greater than the stop permission vehicle speed Sa is set as the pre-vehicle stop driving vehicle speed Sb in the above condition (1). In the present embodiment, the pre-vehicle stop driving vehicle speed Sb corresponds to a second prescribed vehicle speed.

If the pre-vehicle stop driving condition fails to be met (S104: NO), in above step S101, the electronic control unit 32 closes the on-off valve 28, and stops the ejector 26.

Effect

Next, the effect that occurs in the operation state of the vehicle as a result of performing the above ejector driving control routine will be described.

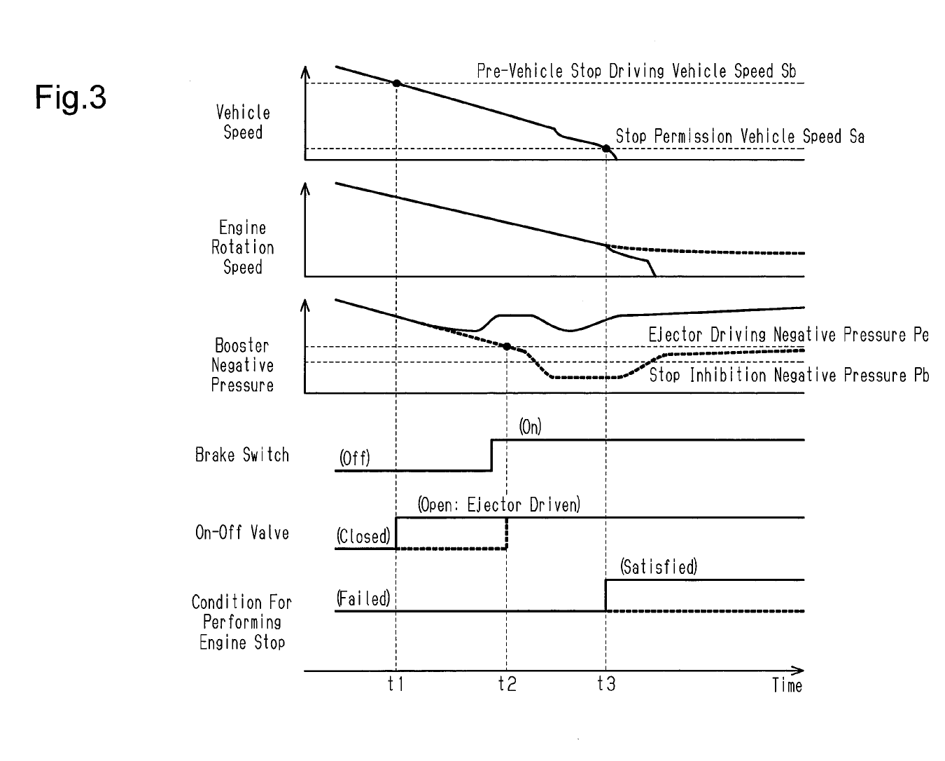

FIG. 3 shows an example of changes of the operation state of the vehicle to which the engine stop control device according to the present embodiment is applied before and after the vehicle stop when the compressor 11 is driven with an air conditioner load that is greater than or equal to the above ejector driving request load Le. FIG. 3 shows the changes of the operation state of the vehicle when the driving of the ejector 26 in accordance with the satisfaction of the pre-vehicle stop driving condition is not performed with dashed lines as a comparative example.

When the speed is reduced to stop the vehicle, the vehicle speed is reduced so that the engine rotation speed is reduced. This reduces the intake pipe negative pressure. This reduces the booster negative pressure of the brake booster 50, which is generated by introducing the intake pipe negative pressure, as well. In the comparative example, at a time point t2 when the booster negative pressure is less than the ejector driving negative pressure Pe, the on-off valve 28 is opened and the driving of the ejector 26 is started. In this case, if the air conditioner load is low, the booster negative pressure is promptly recovered after the start of driving the ejector 26. This avoids a phenomenon in which the booster negative pressure is less than the stop inhibition negative pressure Pb.

However, if the air conditioner load is high, the engine load is increased as well. This reduces the intake pipe negative pressure. This delays the recovery of the booster negative pressure after the start of driving the ejector 26. Accordingly, if the driving of the ejector 26 is started at the time when the booster negative pressure is less than the ejector driving negative pressure Pe, the booster negative pressure is not recovered before the vehicle speed is reduced to be less than the stop permission vehicle speed Sa. Therefore, the performing of the engine stop by the engine stop control is likely to be inhibited due to the shortage of the booster negative pressure. As a result, the opportunities for performing the engine stop is reduced so that the improvement effect of the fuel efficiency by performing the engine stop control is likely to be reduced. In the case of the comparative example shown in FIG. 3, even after the vehicle stop, the condition for performing the engine stop fails to be met and the operation of the engine 10 continues even in the period in which the vehicle is in the stopped state.

In contrast, in the present embodiment, if the air conditioner load is greater than or equal to the ejector driving request load Le, the pre-vehicle stop driving condition is satisfied at a time point t1 when the vehicle speed is reduced to be less than the above pre-vehicle stop driving vehicle speed Sb, and the on-off valve 28 is opened. This starts the driving of the ejector 26 earlier than in the case of the comparative example so that the booster negative pressure that is greater than or equal to the stop inhibition negative pressure Pb is easily ensured until the vehicle speed is reduced to be less than the stop permission vehicle speed Sa even if the air conditioner load is high and the recovery of the booster negative pressure is delayed. Accordingly, in the case of the present embodiment, at a time point t3 when the vehicle speed is less than the stop permission vehicle speed Sa, the condition for performing the engine stop is satisfied and the engine 10 is stopped. Accordingly, in the engine stop control device of the present embodiment, the condition in which the sufficient booster negative pressure is ensured is necessary for performing the engine stop. This limits the shortage of the booster negative pressure and the reduction of the opportunities for performing the engine stop caused by the shortage of the booster negative pressure.

The above described engine stop control device according to the present embodiment has the following advantages.

(1) In the present embodiment, if the air conditioner load is greater than or equal to the ejector driving request load Le, the ejector 26 is driven at a vehicle speed that is greater than or equal to the stop permission vehicle speed Pb. Accordingly, even if the air conditioner load is high and it takes some time to recover the booster negative pressure by driving the ejector 26, the inhibition of performing the engine stop by the engine stop control due to the shortage of the booster negative pressure is less likely to be performed. This suitably ensures the booster negative pressure and the opportunity for performing the engine stop.

(2) In the present embodiment, the condition in which the vehicle speed is less than the pre-vehicle stop driving vehicle speed Sb that is set greater than the stop permission vehicle speed Sa is a further condition for driving the above ejector 26. Accordingly, the ejector 26 is driven only if the necessary condition on the vehicle speed for performing the engine stop by the engine stop control is likely to be satisfied. This limits the unnecessary driving of the ejector 26. This limits the power consumption of the electromagnetic driving type on-off valve 28, to which a current is supplied to be opened when driving the ejector 26. This limits the degradation of the fuel cost of the engine due to the increase of the power generation load in turn.

The above embodiment may be modified as follows.

In the above embodiment, an upper limit (pre-vehicle stop driving vehicle speed Sb) is set for the vehicle speed in which the ejector 26 is driven in accordance with the satisfaction of the pre-vehicle stop driving condition. However, the ejector 26 may be driven without setting the upper limit of the vehicle speed. That is, the above condition (1) may be relaxed to only a condition in which the vehicle speed is greater than or equal to the above stop permission vehicle speed Sa. Even in this case, the advantage of the above condition (1) is obtained. Further, even in this case, if the upper limit condition of the booster negative pressure or the intake pipe negative pressure is added to the pre-vehicle stop driving condition, the unnecessary driving of the ejector 26 is limited.

In the above embodiment, it is determined whether the booster negative pressure is over the prescribed stop inhibition negative pressure Pb to determine whether the performing of the engine stop in the engine stop control is inhibited. If the booster negative pressure sensor 22 is not provided, the determination may be made by using the intake pipe negative pressure detected by the intake pipe negative pressure sensor 16 in place of the booster negative pressure. Further, the determination of step S101 in the ejector driving control routine in FIG. 2 is performed by using the intake pipe negative pressure in place of the booster negative pressure in the same way.

A pressure sensor that detects the absolute pressure of the downstream portion of the intake passage 12 from the throttle valve 15 or the absolute pressure in the negative pressure chamber 18 of the brake booster 50 may be used in place of the intake pipe negative pressure sensor 16 and the booster negative pressure sensor 22. In this case, the same engine stop control and the same ejector driving control are performed as in the above embodiment by obtaining the intake pipe negative pressure and the booster negative pressure from the atmospheric pressure and the detection results of the sensors. Assuming that the atmospheric pressure is constant, the detection values of the absolute pressure are used as index values of the intake pipe negative pressure and the booster negative pressure. In this case, the size relation of the comparison expression used for the determination between the right and left sides is inverted.

In the above embodiment, the vehicle speed is obtained from the detection result of the vehicle speed sensor 35, which detects the rotation speed of the wheels. Alternatively, the vehicle speed may be obtained from the detection result of the rotation speed of the output shaft of the transmission and the differential gear ratio, or the vehicle speed may be obtained from the detection result of the rotation speed of the input shaft of the transmission and a set of the transmission ratio and the differential gear ratio.

In the above embodiment, the electromagnetic driving type valve is employed for the on-off valve 28. However, an on-off valve of another type may be employed.

In the above embodiment, the ejector 26 is driven if the vehicle speed is greater than or equal to the stop permission vehicle speed Sa and the air conditioner load is greater than or equal to the ejector driving request load Le. However, the determination whether the above driving of the ejector 26 is necessitated may be performed by using the driving load of an auxiliary machine other than the compressor 11 or the sum of the driving loads of a plurality of auxiliary machines in place of the above air conditioner load.

1. An engine stop control device that stops an engine if a vehicle speed is less than a prescribed vehicle speed and a booster negative pressure of a brake booster is greater than or equal to a prescribed negative pressure, the engine stop control device comprising:
an ejector, which increases the booster negative pressure; and
a controller programmed to control the engine and the ejector, wherein if a condition in which the vehicle speed is greater than or equal to the prescribed vehicle speed and a driving load of an auxiliary machine of the engine is greater than or equal to a prescribed load is satisfied, the controller drives the ejector
wherein when the prescribed vehicle speed is defined as a first prescribed vehicle speed and a prescribed vehicle speed that is greater than the first prescribed vehicle speed is defined as a second prescribed vehicle speed, a further condition in which the vehicle speed is less than the second prescribed vehicle speed is established for driving the ejector.

2. An engine stop control device that stops an engine if a vehicle speed is less than a prescribed vehicle speed and a booster negative pressure of a brake booster is greater than or equal to a prescribed negative pressure, the engine stop control device comprising:
an ejector, which increases the booster negative pressure; and
a controller programmed to control the engine and the ejector, wherein if a condition in which the vehicle speed is greater than or equal to the prescribed vehicle speed and a driving load of an auxiliary machine of the engine is greater than or equal to a prescribed load is satisfied, the controller drives the ejector while maintaining the drive of the auxiliary machine
wherein when the prescribed vehicle speed is defined as a first prescribed vehicle speed and a prescribed vehicle speed that is greater than the first prescribed vehicle speed is defined as a second prescribed vehicle speed, a further condition in which the vehicle speed is less than the second prescribed vehicle speed is established for driving the ejector.

3. (canceled)

4. The engine stop control device according to claim 1, wherein the controller drives the ejector such that the booster negative pressure is recovered to be greater than or equal to the prescribed negative pressure.

5. The engine stop control device according to claim 1, wherein
the auxiliary machine includes a compressor for an air conditioner, and
if the vehicle speed is greater than or equal to the prescribed vehicle speed and a driving load of the compressor for an air conditioner is greater than or equal to a prescribed load, the controller drives the ejector.
